(19) United States
(12) Patent Application Publication
(10) Pub. No.: US 2012/0303710 A1
(43) Pub. Date: Nov. 29, 2012

(54) SYSTEMS AND METHODS FOR GENERATING AND EMPLOYING A SOCIAL MEDIA GRAPH

(75) Inventors: Dale T. Roberts, San Anselmo, CA (US); Markus K. Cremer, Orinda, CA (US)

(73) Assignee: Gracenote, Inc., Emeryville, CA (US)

(21) Appl. No.: 13/480,339

(22) Filed: May 24, 2012

Related U.S. Application Data
(60) Provisional application No. 61/490,992, filed on May 27, 2011.

(51) Int. Cl. G06F 15/16

(52) U.S. Cl. 709/204

(57) ABSTRACT

Methods and systems for generating and employing a social media graph are disclosed. For example, a method can include receiving first data indicating consumption of media by a first user from at least one user device associated with the first user. Second data including metadata identifying the media consumed by the first user may be retrieved based on the first data. The second data may be processed to generate a social media profile for the first user, the social media profile identifying the media consumed by the first user. In some examples, the social media profile may be used to provide media recommendations to another user, to provide at least some of the media associated with the social media profile to another user, or to facilitate other tasks.

### RELATED APPLICATIONS

This application claims the benefit of U.S. Provisional Application No. 61/490,992, titled “SYSTEMS AND METHODS FOR GENERATING AND EMPLOYING A SOCIAL MEDIA GRAPH,” filed May 27, 2011, which is hereby incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2012, Gracenote, Inc. All Rights Reserved:

### TECHNICAL FIELD

This application relates generally to social networking and, more specifically, to systems and methods for the generation and employment of a social graph associated with media content.

### BACKGROUND

In current online social networking applications, such as Facebook®, users possess an ability to post photographs and textual messages to be shared with their “friends.” To a limited extent, users may also identify and recommend particular movies, actors, songs, musical artists, and so on by way of these same text messages, which may include links to websites associated with the identified media content. However, such recommendations are not necessarily connected to the actual media content being recommended to facilitate access to that content. In addition, a recommendation of this type may not reflect, or be connected with, actual content being consumed by the user providing the recommendation.

In other examples, the social network application may provide a formalized mechanism by which users may indicate approval of other sites or “pages” accessible via the application, such as the “like” mechanism provided by Facebook®. However, this mechanism is typically facilitated by way of the pages associated with the content, and thus does not represent a recommendation provided by another user, such as a friend. In addition, while some pages accessible via a social network application provide access to the actual content, many other pages that are presumably associated with a particular recording artist or other entity associated with media content are in fact not associated with the media content, and thus do not provide direct or convenient access to that content. Further, distinguishing between such “real” and “fake” pages for the purposes of directing users to the real sites is problematic.

### BRIEF DESCRIPTION OF THE DRAWINGS

Some embodiments are illustrated by way of example and not limitation in the figures of the accompanying drawings in which:

FIG. 1 is a block diagram illustrating an example social media network system;

FIG. 2 is a flow diagram illustrating an example method for generating a user social media profile;

FIG. 3 is a block diagram illustrating an example user social media profile;

FIG. 4 is a flow diagram illustrating an example method for providing user recommendations associated with consumed media content;

FIG. 5 is a flow diagram illustrating an example method of generating and providing a video presentation associated with a first user to a second user;

FIG. 6 is a flow diagram of an example method for generating an audio/video presentation which includes music consumed by user;

FIG. 7A is a depiction of an example video display providing access to a social networking television channel welcome screen;

FIG. 7B is a depiction of an example video display providing access to a particular friend's information associated with the social networking television channel;

FIG. 8 is a block diagram of an example user experience module of FIG. 1; and

FIG. 9 is a diagrammatic representation of a machine in the example form of a computer system within which a set of instructions for causing the machine to perform any one or more of the methodologies discussed herein may be executed.

### DETAILED DESCRIPTION

Example methods and systems for the generation and employment of a social media graph are discussed. In the following description, for purposes of explanation, numerous specific details are set forth in order to provide a thorough understanding of example embodiments. It will be evident, however, to one skilled in the art that the present subject matter may be practiced without these specific details. It will also be evident that the types of media content described herein are not limited to the examples provided and may include other scenarios not specifically discussed.

Generally, a social media graph may include at least one social media profile for each user of a particular community, such as an online social network (for example, Facebook®). A social media profile may identify one more types of media, including, but not limited to, audio/video content (for example, movies, television programs, sporting events, music concerts, animated Content, personal or family-related audio/video content, and the like), audio content (for example, songs, speeches, podcasts, and so on), and photographic and still image content (for example, photos, created digital images, and so forth), that are owned or consumed by the user, along with other media-related information. Once the information for a social media profile is generated, the information included in the social media profile may be employed to facilitate a number of functions, including, but not limited to, the recommendation of media items referenced in the profile, and the delivery of media referenced in the social media profile to other users.

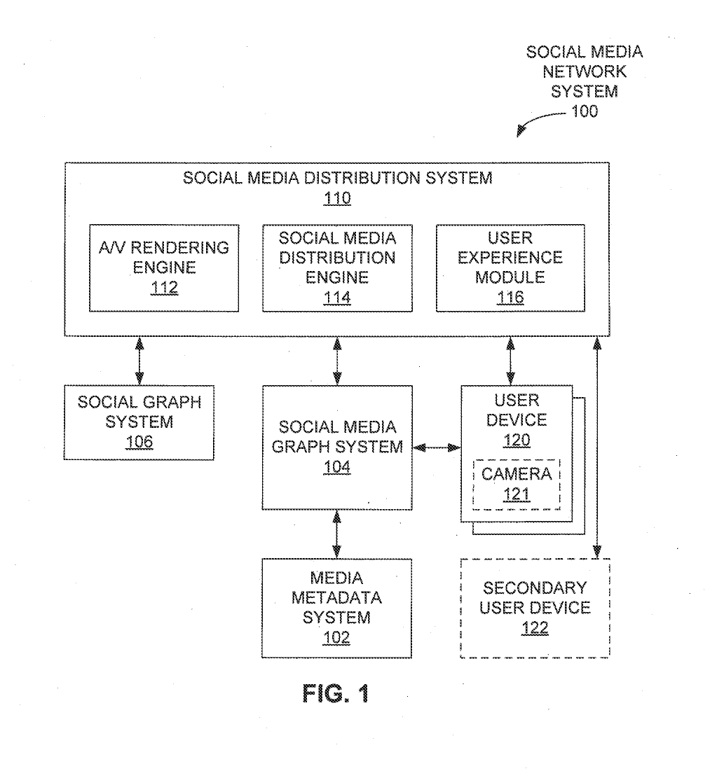

FIG. 1 illustrates an example social media network system 100 including a media metadata system 102, a social media graph system 104, a social graph system 106 (for example, Facebook®), a social media distribution system 110, and one or more user devices 120. Optionally, a secondary user device 122-associated with a user device 120 may also be included. Other components not depicted in FIG. 1 may also be included in the social media network system 100 in other implementations.

Each user device 120 may be any output or presentation device employed by a user to consume media content, such as textual, video-only, audio-only, and/or audio-video content. Examples of the user device 120 include, but are not limited to, televisions, video monitors, television set-top boxes (STBs), audio receivers, desktop or laptop computers, Internet tablets, personal digital assistants (PDAs), and portable communications devices, such as cellular phones. In one example, the user device 120 may include a camera 121, such as a still image or video camera. Possible uses for the camera 121 are described more fully below. The user device 120 may be coupled to either or both of the social media graph system 104 and the social media distribution system 110 by way of a communication network. The communication network may be, for example, a Wide-Area Network (WAN), such as the Internet, a Local-Area Network (LAN), a cellular telephone network, or the like. The user device 120 may be coupled with the communication network by any wired or wireless means, such as, for example, Ethernet, IEEE 802.11x (WiFi), or other means to an Internet gateway, such as a cable or Digital Subscriber Line (DSL) modulator-demodulator (modem).

In one example, one or more of the user devices 120 may be associated with a secondary user device 122. In some implementations, the secondary user device 122 may be a laptop computer, PDA, cellular phone, Internet tablet, or other portable device. In other examples, the secondary user device 122 may be any output or presentation device, as discussed above in conjunction with the user device 120.

The social graph system 106 may be configured to store data regarding a number of users associated by way of an online social network. Examples of the social graph system 106 may include Facebook® and Twitter®. For each user, the social graph system 106 may maintain data identifying the user's friends on the network, the user's likes and dislikes regarding any number of subject areas (including media content), news regarding the user, photographs posted by the user, information posted on a virtual “wall” associated with the user, and other information. The social graph system 106 may also host a number of “pages” or network sites associated with musical artists, actors, movies, television programs, events, products, and so on.

Each of the user devices 120, the social graph system 106, and the social media graph system 104 may be coupled by a communication network, such as the Internet, to a social media distribution system 110. In one example, the social media distribution system 110 may be configured to provide specialized audio/video content associated with each of a number of users, such as the users of the social graph system 106, for viewing by way of the user device's 120. In FIG. 1, the social media distribution system 110 includes an audio/video rendering engine 112, a social media distribution engine 114, and a user experience module 116. Example functionality of each of these modules 112-116 is described in greater detail below.

The media metadata system 102 may be configured to ascertain the identity of an item of media content, such as a video item, an audio item, a still image, and the like. In one example, the media metadata system 102 may receive some representation of the media item, such as a digital “fingerprint” or other mathematical representation of the media item, or a portion of the media item itself, and compare that representation to a database in which representations and associated metadata regarding multiple media items is stored. If the representation matches a corresponding representation for one of the media items referenced in the database, the media metadata system 102 may then return an identity of the media item. In one example, the media metadata system 102 may store a unique identifier for each media item represented in the database. The media metadata system 102 may store information related to movies, television programs, sporting events, audio Compact Discs (CDs) and their included tracks, and any other type of media item. In one implementation, the media metadata system 102 may also include interactive program guide (IPG) or electronic program guide (EPG) information related to a satellite, cable, or terrestrial (“over-the-air”) television service provider. The IPG or EPG information may be used to identify a particular program given a particular viewing channel and viewing time associated with the program.

The social media graph system 104 may be configured to generate a social media profile for each of a number of users. In one example, the social media profile includes data regarding the relationship of the user to various media, which may include both media generated by the user, as well as media generated by others.

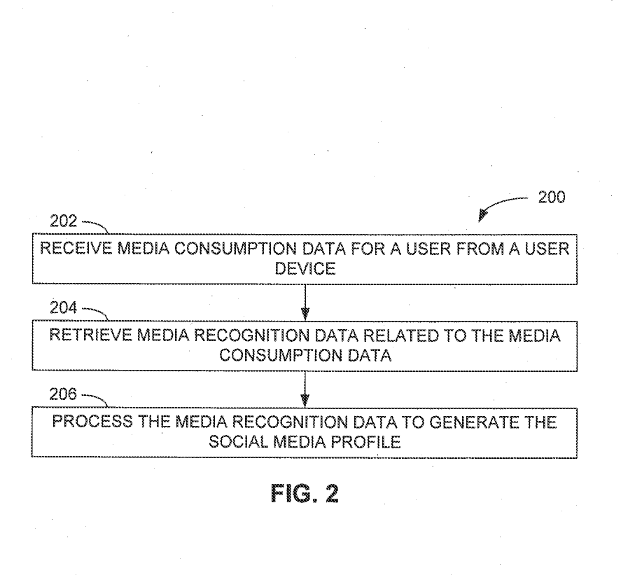

FIG. 2 illustrates an example method 200 of generating the media social profile for a user using the social media graph system 104. In the method 200, the social media graph system 104 may receive media consumption data regarding the consumption and/or ownership of media from the user device 120 (operation 202). This data may include, for example, a digital fingerprint or other data representing at least some portion of a media item that has been consumed (for example, viewed, listened to, downloaded, stored, etc.) as discussed above. In the case of a television program, the data may include a viewing channel and viewing time, possibly with other identifying information. In another example, a television program may be represented by way of closed-captioning data accompanying the program.

In response, the social media graph system 104 may retrieve media recognition data related to, or identifying, the media consumption/ownership data (operation 204). In one example, the social media graph system 104 provides the media consumption data to the media metadata system 102 (FIG. 1), to which the media metadata system 102 may respond by returning the associated media recognition data. In one example, the media metadata system 102 may employ a television EPG or IPG to compare against a received viewing channel and viewing time to determine the particular program consumed. In another example, closed-captioning data associated with a television program, possibly in conjunction with a specific viewing date and time, may be analyzed against the EPG to identify the viewed program. In yet other implementations, a received digital fingerprint of a particular media item may be compared against a collection of fingerprints stored in the media metadata system 102 to determine the identity of the consumed item. In one example, the media recognition data may include a globally unique identifier that specifically identifies the media item consumed by the user.

The social media graph system 104 may process the retrieved media recognition data for use in the social media profile for the user (operation 206). In one example, all or part of the retrieved media recognition data may be stored directly in the social media profile.

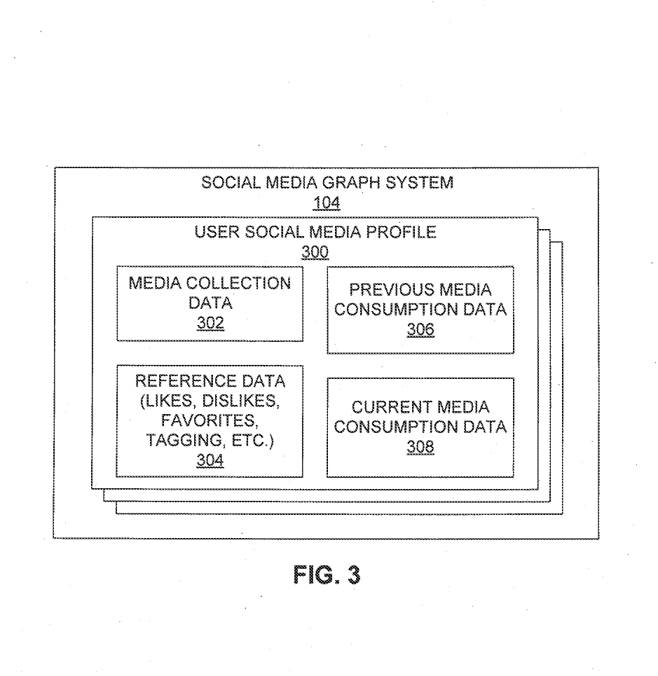

FIG. 3 illustrates an example user social media profile 300 stored within the social media graph system 104. In other examples, the user social media profile 300 for a user may be stored in a database or other data storage system accessible by the social media graph system 104. In some implementations, the social media profile 300 for a user may be viewed as a database of the user's media consumption habits. These habits may be accessible by other users via the social graph system 106 in some embodiments, as described in greater detail below.

In FIG. 3, a user social media profile 300 may include media collection data 302, reference data 304 associated with one or more media items, previous media consumption data 306, and current media consumption data 308. In one example, the media collection data 302 identifies the media items, such as movies, songs, television programs, and the like, currently owned or possessed by the user. The media items may be those produced by others, and/or those media items generated by the user, such as family photos and videos. In some situations, a media item may be obtained from a particular commercial media content supplier or service (e.g., iTunes®). As a result, the media collection data 302 may also include a supplier or service identifier for such items. In some implementations, the media collection data 302 includes media item “playlists” or “party mixes,” which denote a particular group of media items to be presented to a user in a specified or more randomized order. Such a play list may be created by the user or received from another user or system.

The reference data 304 may include, for example, the “likes” and “dislikes” of the user regarding various media items, favorite media items of the user; and tagging information provided by the user or others related to specific media items. In one example, the tagging information may include any of a location, day, date, time, and/or any descriptive information relating to a media item. Such information may relate to the time at which the media item was created, downloaded, saved, viewed, and/or the like. In another example, the tagging information may be stored with the media collection data 302 instead of the reference data 304 of the social Media profile 300.

The previous media consumption data 306 may be data indicating those media items which the user has consumed in the past. Such items may not be Owned or otherwise possessed by the user, and thus may not be included in the media collection data 302. In an example, the previous media consumption data 306 may include an identifier for the media item consumed by the user, the number of times the user consumed the item, the date and time during which the item was consumed, from where the item was retrieved (such as a website Uniform Resource Locator (URL), a particular channel of a broadcast network, a DVD or CD, and so forth), the physical location at which the item was consumed, and/or the user device 120 by which the item was consumed. Other information associated with past consumption of media items may be included in the previous media consumption data 306 in other implementations.

In one particular example, the previous media consumption data 306 may include a reference to an online posting service, such as Twitter®. In that case, an item consumed may be referenced by way of a keyword, hashtag, or other identifier associated with the service. In one specific example, the hashtag may include a combined artist and album title, such as “#<artist><album-title>”. Use of a keyword or hashtag may allow another user to access the actual media content, or associated comments and other information associated with the content. For example, comments in a post referenced in the previous media consumption data 306 may include an identification of a location associated with the actual media content, such as where the content was captured. In some examples, the actual content, such as photos or videos posted in the online posting service, may be retrieved from the online posting service as well.

The current media consumption data 308 may include data associated with a media item that is currently being played, viewed, or otherwise consumed by the user. In one example, the current media consumption data 308 may include an identifier for the media item. Also stored as the current media consumption data 308 may be an address (such as a URL), hashtag, channel identifier, network identifier, online service identifier, or other data indicating how or where the media item may be accessed. Also included in some examples may be data indicating the progress of the current consumption by the user, such as a current time offset from a starting point of the media item. The current user device 120 being employed by the user to view or consume the media item may also be included in the current media consumption data 308. In one example, the current media consumption data 308 may facilitate one or more users to join a first user in viewing the same program, and possibly engage in a chat session simultaneously, as is described more fully below.

In one embodiment, the social media graph system 104, by way of its connection with the media metadata system 102, may “normalize” the media-related pages and other content of the social graph system 106 by analyzing and subsequently qualifying or certifying the content of the social graph system 106 as being authentically associated with one or more specific media items. For example, a network page associated with the social graph system 106 that claims a relationship with a particular media item, actor, singer, band, or media-related event may be one that is officially produced or sanctioned by the media-related entity involved, or may instead be generated by someone without any official connection to the entity. Further, the social media profile 300 of a user may refer to one or more of these pages or sites as a result of the user consuming an associated media item. As a result, the user may have a vested interest in ensuring that the referenced page or site has some official connection with the media item of interest.

To facilitate this normalization, the social media graph system 104 may analyze any pages or sites referenced in the user social media profiles 300, or in other information referenced by either the social media graph system 104 or the social graph system 106, in view of information obtainable from the media metadata system 102. For example, the content of a page, such as video items, audio items, textual information, keywords, stated facts, news, and the like, may be compared to the metadata of the media metadata system 102 to determine a probability that the page is an authentic or official page associated with a particular artist, band, or other entity. If the determined probability exceeds a predetermined threshold, the social media graph system 104 may signify that the page is authentic and is to be designated for further references to the associated media. Oppositely, those pages found to be unofficial in nature may be avoided in the social media graph system 104 for use in the user social media profile 300. In other examples, official or authentic pages may be vetted or verified editorially by a person, such as a content owner, content provider, or a third party, or the normalization may involve both the editorial and automatic processes described above. In addition, these normalization processes may also be applied to links, hashtags, and other forms, indexes, or addresses of media content. Duplicative or redundant media-related pages may be determined and marked appropriately for presentation in the user social media profile 300 or elsewhere in an organized manner. In one example, multiple such media-related pages may be organized via a global identifier schema that indicates which pages are related to the same media, actor, singer, and so on.

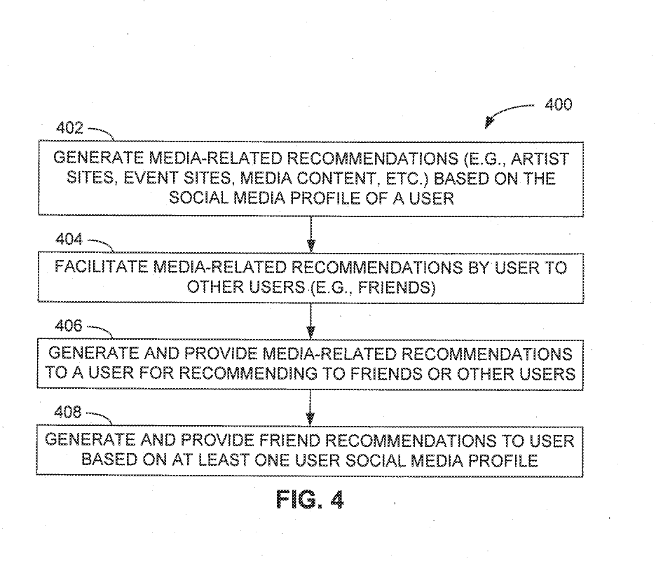

In one example, each of the user social media profiles 300 may be logically connected to other profiles 300 within the social media graph system 104, the social graph system 106, or both according to preexisting relationships between users, such as the users being labeled as “friends.” These logical connections may then be utilized to provide media-related recommendations, such as recommendations to obtain specific songs, movies, or programs, or recommendations for media items associated with specific media-related personnel, such as actors, singers, musical groups, movie directors, and the like. Media-related recommendations may also include recommendations for events, such as upcoming music concerts, movie showings, or television presentations. These recommendations may include links, hashtags, or other mechanisms for allowing a user to access the media content being recommended. FIG. 4 provides an example method 400 of providing such recommendations in a variety of ways. In other examples, only one or some subset of these recommendation operations may be included, as each operation may stand alone, or may be provided in some different order other than that shown in FIG. 4.

In one example, the social media graph system 104 or the social graph system 106 may make media-related recommendations based on a social media profile 300 of a user to a friend or another user (operation 402). For instance, media items that the social media profile 300 indicates that the user likes, or that the user has listed as a favorite, may then be recommended to a friend, or a user with similar media tastes. Other information in the social media profile 300, such as the number of times the user has consumed a particular media item, may also serve as the basis for a media-related recommendation.

In another example, the social media graph system 104 or the social graph system 106 may facilitate explicit media-related recommendations initiated by a user to friends and other users (operation 404). In one implementation, the user may make such a recommendation using favorites and similar data available in the user's social media profile 300. In other cases, the social media graph system 104 or the social graph system 106 may generate and provide media-related recommendations for the user for presentation to a friend or other user (operation 406). For example, a recommendation may be based on media favorites or likes of the user, and may be intended for a friend or other user with similar tastes. The user may then approve the recommendation before the recommendation is delivered to the friend or other user.

Any of the media-related recommendations mentioned above may involve the generation of a playlist to provide the recipient of a recommendation with multiple media examples, such as those related to a particular recording artist, movie director, dramatic or comedic actor, or other entity.

In some implementations, the media-related recommendation may take the form of a pointer, link, hashtag, or other reference to a location from which the recommended media item may be obtained, such as by way of the Internet. The user receiving the recommendation may thus only need to activate the link or perform a similar operation to obtain access to the media item. As a result, the media content being recommended need not be passed from user to user, but instead may be obtained from a retail-oriented or subscription-based page, a social graph or other social site (e.g., Facebook®, Twitter®, and YouTube®), or other network site accessible by way of a communication network. In another example, the users may subscribe to a media access service that allows such access by way of a periodically-paid subscription tee.

In one implementation, the recommended media item may require access to a different commercial media source or a different media content service (e.g., iTunes®) than to that which the recipient of the recommendation has access. Under that scenario, the reference to the media item may include a source or service identifier and a content identifier, as described above in conjunction with media collection data 302 (FIG. 3), optionally along with a mechanism for facilitating e-commerce interactions, such as a referral link, user identification code, or subscription-related information. The social media distribution system 110 may then process this information to allow a recipient of the recommendation to access the same media item from a different source or service to which the recipient has access. In situations in which the service accessible by the recipient cannot provide the recommended media item, the social media distribution system 110 may deliver, reference, or recommend a similar or substitute media item to the recipient. For example, if the media item is a song, the social media distribution system 110 may deliver or recommend a similar song by the same artist or a similar-sounding artist of the same musical genre.

In other examples, a friend or other user associated with a first user may “check in” to the social media profile 300 of the first user to ascertain which media items the first user considers his favorites. The friend or other user may also be presented with reviews and other ancillary information regarding the favorites that have been generated by the first user or others via the social media graph system 104. In at least some cases, the first user may determine which portions of the social media profile 300 are available for access by friends or other users.

In a related function, when a user decides to consume a particular media item, the social media graph system 104 may provide to the user reviews, likes, the identities of which friends are currently watching the same item, and similar information that have been generated by the friends of the user. Such information may be retrieved from the social media profile 300 of each of the friends, in one example.

In some instances, the friend or other user may be able to determine via the social media profile 300 what media the first user is consuming at the moment, and may actually join in viewing or listening to the same media content in real-time. In that example, the user device 120 playing the media item may be capable of streaming the item to the friend or other user simultaneously via the Internet or other communication network. In other instances, the user device 120 of the friend or other user may receive the same program or content from a broadcast source.

In addition to media-related recommendations, the social media graph system 104 or the social graph system 106 may provide to a user a recommendation to befriend another user (operation 408), such as a currently unknown user, or a user that is a “friend of a friend.” Such a recommendation may be based on similar tastes in music, movies, television programs, and other media, or combinations thereof, as reflected in the user social media profiles 300 of the parties involved. In another example, a friend recommendation may be based on differences in taste regarding one or more types of media content.

Thus, in many of the examples described above, the social media graph system 106 may provide means by which users, such as those associated to each other via the social graph system 106, may explore and recommend media content in an efficient and organized manner. In addition, the social media graph system 106 may provide advertising, discounts, and the like related to the media items referenced in a user social media profile 300 to promote the purchase of the items and associated goods and services.

In reference to FIG. 1, the social media distribution system 110 may be configured to provide customized audio and/or video content for a user based at least in part on the media content indicated in the social media profile 300 for that user. In an example to be described in greater detail below, the customized content pertaining to the user may be delivered to the user device 120 as a separate “over-the-top” (OTT) content channel (referred to herein as a social television channel) similar to a broadcast television channel. As discussed above, the social media distribution system 110 may include an audio/video rendering engine 112, a social media distribution engine 114, and a user experience module 116. Other modules not explicitly depicted in the social media distribution system 110 of FIG. 1 may be present therein in other implementations.

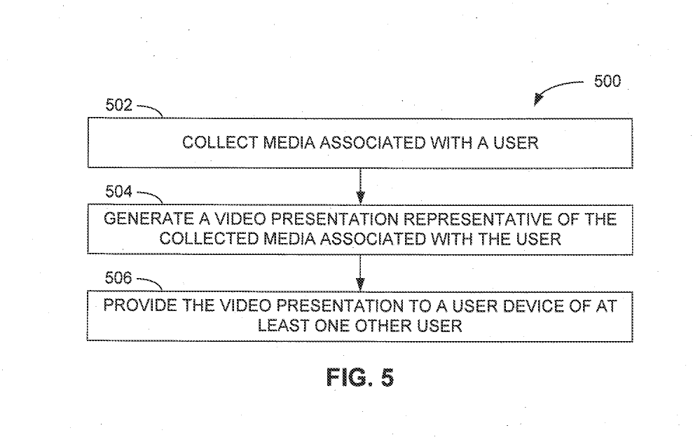

FIG. 5 illustrates an example method 500 for generating and providing to one or more users a customized video presentation associated with a particular user. In the method 500, the audio/video rendering engine 112 may collect media items, or portions thereof, that are associated with the user (operation 502). In one example, the rendering engine 112 retrieves media items that are indicated in social media profile 300 of the user. The media items may be favorites, those items that the user likes, or those items that the user has generated personally. Further, such decisions may be guided by way of template information provided by the user via the user experience module 116, discussed in greater detail below. In one example, the rendering engine 112 may receive the media items via the social media distribution engine 114 from the social media graph system 104, a user device 120 of the user, or another location accessible by the social media distribution system 110.

In one implementation, the media items to be used to generate the customized video presentation may be retrieved based on the social media profile 300 of one or more users associated with the particular user (e.g., friends of the user, acquaintances of the user, or family members related to the user). In an example, the audio/video rendering engine 112 may retrieve video clips or still images captured or generated by one or more friends or relatives of the particular user that involve a topic selected by the user, such as a particular event (e.g., a vacation, a birthday party, or a music concert), a specific location, a particular date and/or time, or some other data indicated in the social media profile 300 of the friends and relatives. In one instance, the particular user may initiate this process by specifying the event, date, or other parameters to be used to access the social media profile 300 of the friends or relatives in order to collect the desired media items.

The rendering, engine 112 may then generate a video presentation representative of or based on, the retrieved media content (operation 504). In one example, the generation of the video presentation may be guided by way of template information provided via the user experience module 116, which may be sourced by the user. In some implementations, the template information may determine where on a display screen various items are to be placed, how long each type of visual content (movie or video clip, still image, and the like) is to be played, whether background audio content (for example, a favorite song) is to be presented with the video information, how long the overall video presentation is to run before repeating, and so on.

The resulting video presentation may be viewed as a kind of “music video” that describes, for example, recent activities of the user (such as a recent vacation or business trip) by way of one or more media items (such as video clips, photo images, music and the like); recent activities of the friends and/or family of the user; recent movies, television programs, or music in which the user has recently taken a particular interest, media items that the user is current consuming, and so forth. The rendering engine 112 may also select specific musical selections from those that the user has indicated are favorites in the social media profile 300 as accompanying music for presentation of video or still images. Such musical selections may be based on the nature of the video or still images involved. For example, the musical selections may be based on a unique identifier (such as a digital fingerprint) or other characteristics or metadata associated with the musical selections, as described above, compared to one or more technical aspects, associated user comments, location references, or other metadata associated with the video or still images. As a result, the videos or still images may be matched and/or timed with musical selections that appear to present a similar timing, energy, theme, and/or “mood.”

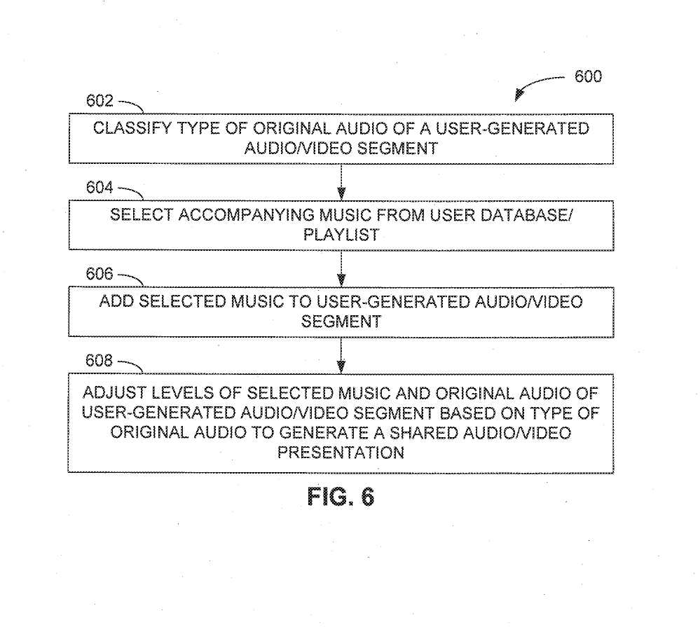

In one particular example, the rendering engine 112 may mix or combine original audio of a video clip with audio from another source (such as a musical recording) for use in the video presentation. FIG. 6 illustrates an example method 600 for performing such a task. In the method 600, the rendering engine 112 may classify a type of original audio of a user-generated audio/video clip or segment (operation 602). In one example, the rendering engine 112 may classify the type of audio based on an analysis of the audio itself, or from a comparison of the audio with other audio signals associated with various common sounds, such as wind and other background noises, human speech, music, and the like.

The rendering engine 112 may then select accompanying music from a user database or playlist provided by way of the user social media profile 300 (operation 604). The rendering engine 112 may select the music according to a particular theme associated with the video clip (such as, for example, “cars” or “vacation”). The theme may be expressed in tagging information that is associated with the video clip and provided by the user. In other examples, the rendering engine 112 may analyze the video or original audio information of the video clip to derive the theme, such as by way of a digital fingerprint of the original audio.

The rendering engine 112 may then add the selected music to the user-generated audio/video segment or clip (operation 606) and adjust the relative audio levels of the selected music and the original audio based on the type of the original audio (operation 608). For example, if the type of the original audio is background audio, such as wind noise, the rendering engine 112 may reduce the audio level of the original audio while increasing the audio level of the selected music. Oppositely, if the type of audio is human speech, the rendering engine 112 may increase the audio level of the original audio while decreasing the audio level of the selected music. Further, these adjustments in audio levels may occur multiple times throughout a single video clip, as the type of the original audio associated with the video clip may change one or more times throughout the clip. With respect to the method 500, in one example, the rendering engine 112 may determine the current physical or geographical location of the user, such as by way of the current media consumption data 308 of the user social media profile 300. Such a fact may be presented as part of the video presentation, possibly along with a map of the location, as well as video clips, audio clips, still images, and the like that are representative of the area.

In some embodiments, the rendering engine 112 may periodically or continually update or revise the video presentation over time based on more recent media consumption of the user associated with the video presentation, changes in user status or location, and other data involving the user. In addition, such rendering may occur in the user device 120, such as a set-top box or television, which may access the social media graph system 104 to retrieve still images, video clips, and other media content and related information to generate and update a video presentation.

Once the rendering engine 112 has generated the video presentation, the rendering engine 112 may make the video presentation available to the social media distribution engine 114, which provides the video presentation to a user device of at least one other user (operation 506). For example, the video presentation may be provided via the Internet or other communication network to one or more friends of the user, as determined via the social graph system 106.

In one implementation, one or more video clips, still images, audio segments, and other components of the video presentation are items that may be retrieved from a media content source or service to which the recipient of the video presentation has access. In that situation, one or more of the components of the video presentation may be represented by a source or service identifier and a content identifier, as described above in conjunction with the media collection data 302 (FIG. 3). This information may then allow the social media distribution system 110 to facilitate access to the item by the recipient during playback of the video presentation. In some examples, such an item involves a different commercial media source or a different media content service (e.g., iTunes®) than that to which the recipient of the video presentation has access. As a result, the social media distribution system 110 may provide a substitute item that is both similar to the originally specified item and is accessible by a media source or service to which the recipient of the video presentation has access.

In some implementations, the recipients of the video presentation may affect the content of the presentation, such as by voting to promote, remove, or change one or more components of the presentation. The recipient users may provide such feedback by way of the social graph system 106 (FIG. 1) or another system. The audio/video rendering engine 112 may alter the components or content of the video presentation based on the recipient feedback attaining some level of positive or negative feedback.

As mentioned above, the social media distribution engine 114 may provide to one or more user devices 120 a social media television channel over the Internet or other communication network, wherein the channel is distinguished from other broadcast or video-on-demand (VOD) channels that may received at the user device 120, and presented to a user by way of a video display.

In one case, the user may select the social television channel by way of a particular channel number selection on a remote control, but many other methods of selecting the channels, such as the selection of an on-screen icon, are also possible. In one example, access to the social television channel may be facilitated by way of a user interface that is presented as an overlay atop the display of another channel or source of video content currently being viewed. In another implementation, the user interface may be provided as a type of picture-in-picture (PIP) or side-by-side display in which access to the social television channel does not obscure the currently viewed program.

In yet another example, the user may use the secondary user device 122 of FIG. 1 to facilitate access to the video television channel via the user device 120, to provide configuration information for the channel, and to perform other functions related to the social media distribution system 110. Such information may be entered by the user while the social television channel is being viewed, this altering the content and/or formatting of the social television channel in real-time. In an example, the user may also enter tagging information related to any media content consumed by the user. In addition, the secondary user device 122 may present the social television channel and related friend channels to the user in a manner similar to that as the user device 120.

In one example, the social television channel includes one or more of the video presentations generated by the audio/video rendering engine 112. In some examples, the video presentations, each of which may be associated with a particular friend or other user, may be provided serially in some predetermined order (for example, by order of importance, or by order of most recent contact with the friend) or in random order. Further, each of the video presentations may be presented concurrently or simultaneously on the social television channel. In one example, the social television channel may provide a logical gateway by which a user may access media content associated with friends and other users, as well as more traditional social network content associated with the social graph system 106.

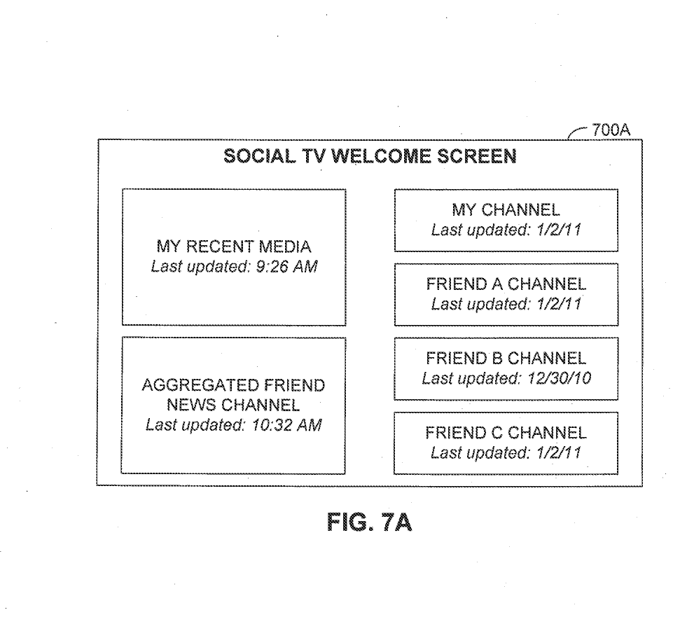

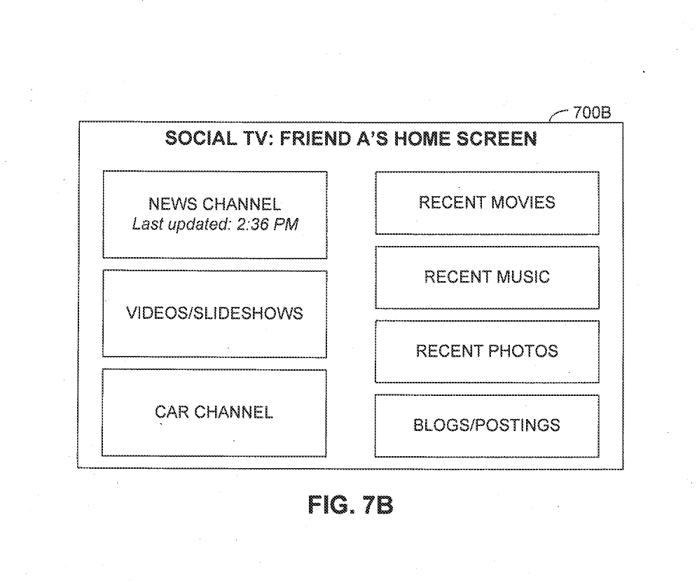

FIG. 7A illustrates an example video display of a main, or “welcome,” screen 700A for a social television channel, as described herein. In this example, the welcome screen displays the video presentation associated with the user of the user device 120 (“MY CHANNEL”) simultaneously with video presentations associated with three friends (FRIEND A CHANNEL, FRIEND B CHANNEL, and FRIEND C CHANNEL). In other examples, a basic representation of each of the channels may be provided, from which the user may select for viewing as a full-screen display, thus providing means by which the user may browse through the “channels” associated with the friends of the user. In FIG. 7A, the welcome screen may also include other information pertinent to the user of the user device 120, such as an indication of media recently consumed or received by the user (MY RECENT MEDIA) and a social network oriented news channel (AGGREGATED FRIEND NEWS CHANNEL) providing updates from multiple friends of the user.

In some implementations, the audio/video rendering engine 112 may generate a kind of virtual “newscaster” for presenting news updates regarding friends of the user via the Aggregated Friend News Channel of the welcome screen 700A. For instance, the virtual newscaster may be an audio-only or audio/video representation of a person relaying or announcing events occurring in the lives of the user's friends, presented in a newscast format. In an example, the rendering engine 112 may generate speech from text reflecting the news updates, incorporated with video of an actual person or an animated newscaster. Additionally, still photos or video clips related to the news updates may be presented in a format similar to that found in an actual broadcast, such as an “over-the-shoulder” windowed display of the photos or video provided in conjunction with the virtual newscaster.

Other information associated with the social graph system 106 or the social media graph system 104 may also be provided on the welcome screen 700A. Examples of such information may include, for example, a listing of “check-ins” by friends into content consumed by the user, recent photos posted by friends (which May be animated and/or accompanied with music associated with either the friend or the user), recent video clips (possibly set to music), “likes” of the day by the user and friends of the user, and a listing of friends associated with friends of the user.

The types of content provided on the welcome screen, as well as the positioning of those elements and other selectable parameters applicable to the welcome screen, may be selected by the user of the user device 120, such as by way of data stored in the user experience module 116. The social media distribution engine 114 may then employ that information to select and format the particular video presentations and other content to be presented to the user.

FIG. 7B illustrates a friend-specific screen 700B, which may result from the user selecting the FRIEND A CHANNEL area of the welcome screen 700A of FIG. 7A. The friend-specific screen 70013 may provide multiple areas for displaying and/or accessing media consumed by, or associated with, Friend A, such as recent movies, music, and photos, as well as videos and slideshows generated by Friend A. In the example of FIG. 7B, Friend A may also provide one or more special thematic personal media channels (in this case, a CAR CHANNEL) providing media content germane to a particular subject of interest. Also included in this friend-specific screen 70013 is a NEWS CHANNEL describing recent events involving Friend A, such as by way of text, photos, videos, and the like. Other content not specifically tied to audio or video media may also be accessed, such as weblogs (“blogs”) hosted by Friend A, or favorite blogs of Friend A, as well as specific blog postings by Friend A.

In one implementation, the information accessible via the friend-specific screen 700B is an example of a video presentation generated by the audio/video rendering engine 112 of the social media distribution system 110, as discussed above. For example, the various types of information depicted in FIG. 7B may be presented as a collage with multiple types of content being presented concurrently, possibly With background music identified via the social media profile 300 of Friend A. The various movies, music, photos, and other media content may also be identified in the social media profile 300 as well. In some examples, the content being presented may be associated with a link, hashtag, or other mechanism by which a viewer may access the content directly for purchase or consumption. In other examples, the various types of media content may be presented serially in a “round robin” fashion, with the series possibly being repeated continually. The particular format of the friend-specific screen 700B may be specified according to information provided by Friend A by way of the user experience module 116 of the social media distribution system 110. In one example, similar user experience information provided by the user of the user device 120 presenting the friend-specific screen 700B may also influence the format and/or content of the screen 700B.

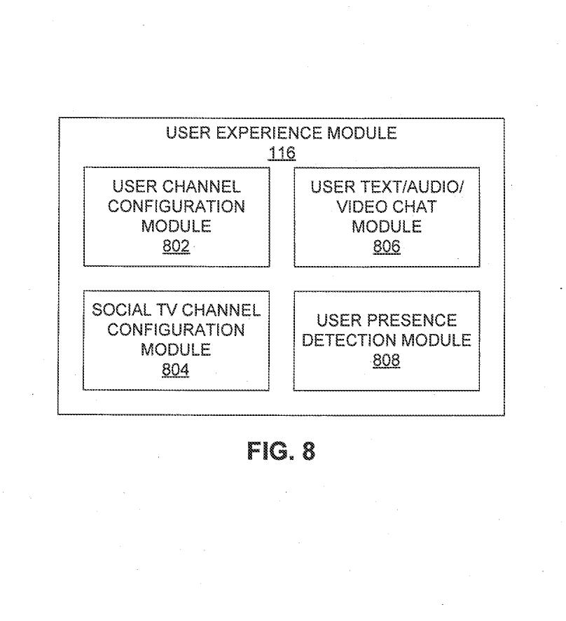

FIG. 8 illustrates an example user experience module 116 of the social media distribution system 110 of FIG. 1. In an example, the user experience module 116 includes a user channel configuration module 802, a social television channel configuration module 804, a user text/audio/video chat module 806, and a user presence detection module 808. Additional modules not explicitly shown in FIG. 8 may also be included in the user experience module 116 in other implementations.

The user channel configuration module 802 may provide information to the audio/video rendering engine 112 regarding the content, format, and other configurable aspects of the video presentation associated with a user. In an example, the content is referenced in the social media profile 300 of the user. Various implementations may allow the user to define which media and other content to include in the presentation, how the content is presented and formatted on a display screen, an order in which the content may be presented, and so on.

The social television channel configuration module 804 includes information that is accessible to the social media distribution engine 114 for formatting and/or configuring the media and other content that is to be presented on the social television channel to the user. Such information may include, but is not limited to, which friend's video presentations (or “channels”) are to be accessible via the social television channel, how those channels are to be presented to the user (for example, simultaneously via multiple windows, serially, and so on), what type of media content associated with each friend may be presented to the user, what additional information may be presented along with the friends' channels, and what background music is to be used for the social television channel. Some of this configuration information may be viewed as one or more filters determining what information may be presented from a friend's channel, and what information may be blocked, in terms of type of content, time of consumption, and other factors.

The user may enter information for the user channel configuration module 802 and the social television configuration module 804 by way of a template or other data entry mechanism provided by the user experience module 116 to the user device 120 via the Internet or other communication network. In one example, the user experience module 116 may provide multiple preset configurations, from which the user may choose one to facilitate the configuration process. In some instances, the user may enter data for the user experience module 116 to direct the content, format, and other aspects of the video presentation associated with the user, or similar aspects of the social television channel and/or any associated friend channels, in real-time. As indicated above, such information may be entered via the user device 120, a remote control of the user device 120, and/or the secondary user device 120, which may be executing a specialized application facilitating the entry of the information.

The user text/audio/video chat module 806 may facilitate the formation of chat sessions involving two or more users. From the user's perspective, any audio or video capabilities for a chat session may be facilitated by way of a camera 121 and/or a microphone coupled with the user device 120. Such chat sessions may be initiated without regard to the particular media content currently being consumed by those engaging in the chat session. In other examples, the social media graph system 104 or the user chat module 806 may detect when two or more friends are watching the same television program or other media simultaneously. In such circumstances, the user chat module 806 may inform one or more of the users viewing the program that friends of the user are also viewing the program, and may provide the ability for the user to initiate or join a contemporaneous chat session to facilitate a discussion involving the program.

The user presence detection module 808 may be configured to alter the content, formatting, or other aspects of the social television channel and/or related user or friend channels being presented over a user device 120 in response to detection of people in proximity to the user device 120. For example, presuming the incorporation of the camera 121 into the user device 120, face detection technology may be employed to determine the identity of one or more people in the same room with the user device 120. In other examples, radio-frequency identification (MD) technology may be employed in cases in which those in the presence of the user device 120 may carry RFID devices, thus allowing the user device 120 to determine the identity of the RFID device carriers. In yet other implementations, one or more of those in the presence of the user device 120 may carry a cellular phone executing an application that provides identity information to the user device 120 indicating the identity of the owner of the phone. The secondary user device 121 may also be employed to determine the identity of those present, such as by way of a camera or other component. Other methods by which those in the presence of the user device 120 are identified may be employed in other examples.

Based on the detected presence of individuals in proximity of the user device, the user presence detection module 808 may alter the content, formatting, and/or other aspects of the social television channel and other user channels appropriate for those in the presence of the user device 120. For example, if certain content shown on those channels may be deemed inappropriate for children or other family members, the user presence detection module 808 may communicate with the social media distribution engine 112 or the audio/video rendering engine 112 to alter the content accordingly. In another example, if two or more people, such as a husband and wife, are present, the user presence detection module 808 may cause only that content which involves friends that are common to those parties to be presented. Other methods of modifying the content or format of the presentations based on the presence of certain individuals, as well as on any relationship between the individuals, may be implemented in other examples.

To implement some or all of the various technologies described above, the social media distribution system 110, the social media graph system 104, the social graph system 106, or other systems not explicitly described herein may provide one or more application programming interfaces (APIs) or other interfacing logic or circuitry to allow the user device 120 to communicate with the various systems described herein to facilitate those technologies.

While specific methods, tasks, operations, and data described herein are associated above with specific systems, other embodiments in which alternative apportionment of such tasks and data among the various systems are also possible. Further, while various systems, such as the social media distribution system 110, the social graph system 106, the social media graph system 104, and the media metadata system 102 are shown as separate entities in FIG. 1, one or more of these systems may be combined into one or more larger computing systems in other embodiments.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or Other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

Example embodiments may be implemented in digital electronic circuitry, or in computer hardware, firmware, or software, or in combinations thereof. Example embodiments may be implemented using a computer program product (e.g., a computer program tangibly embodied in an information carrier in a machine-readable medium) for execution by, or to control the operation of, data processing apparatus (e.g., a programmable processor, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communications network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a field programmable gate array (FPGA) or an application-specific integrated circuit (ASIC)).

The computing system can include clients and servers. A client and server are generally remote from each other and typically interact through a communication network. The relationship of client and server arises by virtue of computer programs running on their respective computers and having a client-server relationship to each other. In embodiments deploying a programmable computing system, it will be appreciated that both hardware and software architectures may be considered. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set forth hardware (e.g., machine) and software architectures that may be deployed in various example embodiments.

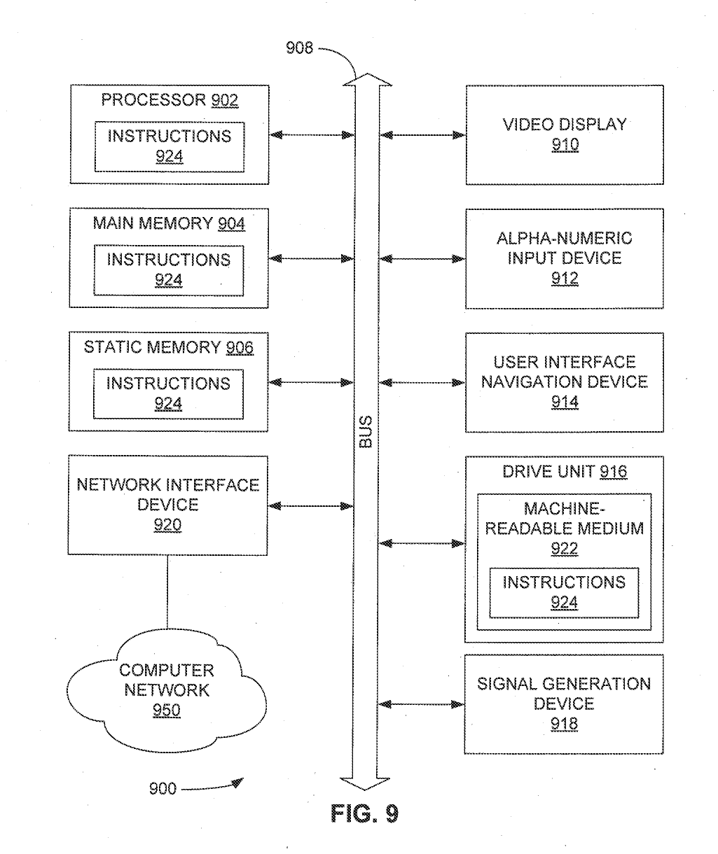

FIG. 9 is a block diagram of a machine in the example form of a computer system 900 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (SIB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU), or both), a main memory 904, and a static memory 906, which communicate with each other via a bus 908. The computer system 900 may further include a video display unit 910 (e.g., a liquid crystal display (LCD) or a cathode ray tube (CRT). The computer system 900 also includes an alphanumeric input device 912 (e.g., a keyboard), a user interface (UI) navigation device 914 (e.g., a mouse), a disk drive unit 916, a signal generation device 918 (e.g., a speaker), and a network interface device 920.

The disk drive unit 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions 924 or data structures. The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non-transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

The instructions 924 may further be transmitted or received over a computer network 950 using a transmission medium. The instructions 924 may be transmitted using the network interface device 920 and any one of a number of well-known transfer protocols (e.g., HTTP). Examples of communication networks include a local area network (LAN), a wide area network (WAN), the Internet, mobile telephone networks, Plain Old Telephone Service (POTS) networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible media to facilitate communication of such software.

Thus, methods and systems for generation and employment of a social media graph have been described. Although the present subject matter has been described with reference to specific example embodiments, it will be evident that various modifications and changes may be made to these embodiments without departing from the broader scope of the subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” and so forth are used merely as labels and are not intended to impose numerical requirements on their objects.

The Abstract of the Disclosure is provided to comply with 37 C.F.R. §1.72(b), requiring an abstract that will allow the reader to quickly ascertain the nature of the technical disclosure. The Abstract is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method, comprising:
receiving first data indicating consumption of media by a first user from at least one user device associated with the first user;
retrieving second data comprising metadata identifying the media consumed by the first user based on the first data; and
processing, using at least one processor of a machine, the second data to generate a social media profile for the first user, the social media profile identifying the media consumed by the first user.

2. The method of claim 1, the first user being associated with an online social network.

3. The method of claim 1, the first data comprising data indicating previous media consumption of the first user.

4. The method of claim 1, the first data comprising data indicating current media consumption of the first user.

5. The method of claim 1, the social media profile for the first se comprising identifications of favorite items of media of the first user.

6. The method of claim 1, the social media profile for the first user comprising items of media owned by the first user.

7. The method of claim 1, the social media profile for the first user comprising information specified by the first user, the information describing the items of media referenced in the social media profile.

8. The method of claim 1, further comprising:
presenting to a second user a media item identified in the social media profile of the first user.

9. The method of claim 8, the presenting to the second user of the media item being initiated by the first user.

10. The method of claim 8, the presenting to the second user of the media item being initiated by the at least one processor based on at least one of the social media profile for the first user and a social media profile for the second user.

11. The method of claim 8, the presenting to the second user of the media item comprising replacing the media item with a substitute media item accessible to the second user based on the media item not being accessible to the second user.

12. The method of claim 1, further comprising:
presenting to the first user a recommendation to associate with a second user based on the social media profile of the first user and a social media profile of the second user.

13. The method of claim 1, further comprising:
associating a media item identified in the social media profile of the first user with an online social network page identified with the media item.

14. The method of claim 13, further comprising:
comparing at least one characteristic of the online social network page with media metadata associated with the media item to qualify the online social network page before associating the media item with the online social network page.

15. A system comprising:
at least one processor of a machine and a plurality of modules providing instructions to be executed by the at least one processor, the modules comprising:
an audio/video rendering engine to collect media content consumed by a first user, and to automatically generate an audio/video presentation based on the media content; and
an audio/video presentation engine to provide the audio/video presentation to a user device for display to a second user logically coupled to the first user.

16. The system of claim 15, the first user and the second user being logically coupled as friends via an online social network.

17. The system of claim 15, further comprising:
a user experience module to store at least one of content information and formatting information for the audio/video presentation;
the audio/video rendering engine to automatically generate the audio/video presentation based on the at least one of the content information and the formatting information.

18. The system of claim 15, further comprising:
the user experience module to receive at least a portion of the at least one of the content information and the formatting information from a second user device associated with the second user.

19. The system of claim 15, further comprising:
a user experience module to facilitate at least one of a textual chat connection, an audio chat session, and an audio/video chat session between a user device of the first user and the user device of the second user.

20. The system of claim 15, further comprising:
a user experience module to detect presence of at least one person proximate to the user device of the second user; and
the audio/video presentation engine to modify the audio/video presentation based on the detected presence of the at least one person.

21. The system of claim 20, the user experience module to detect the presence of the at least one person via a camera associated with the user device of the second user, an identifying device carried by the at least one person, and a mobile communication device associated with the user device of the second user.

22. The system of claim 15, the audio/video rendering engine to classify a type of original audio associated with the media content, to select an audio recording from a media collection associated with the first user, to add the selected audio recording to the media content, and adjust audio levels of the original audio and the audio recording for the generated audio/video presentation based on the type of original audio.

23. The system of claim 15, the audio/video rendering engine to identify the media content to be collected based on a social media profile indicating the media content consumed by the first user.

24. The system of claim 15, the audio/video rendering engine to identify the media content to be collected based on a topic selected by the user.

25. The system of claim 24, the topic comprising at least one of an event, a location, a date, and a time.

26. The system of claim 15, the audio/video rendering engine to collect additional media content from a third user, and to generate the audio/video presentation based on the media content and the additional media content.

27. The system of claim 15, the audio/video rendering engine to automatically modify the audio/video presentation based at least in part on feedback received from the second user concerning the audio/video presentation.

28. A non-transitory computer-readable storage medium comprising instructions that, when executed by at least one processor of a machine, cause the at least one processor to perform operations comprising:
receiving first data indicating consumption of media by a first user from at least one user device associated with the first user;
retrieving second data comprising metadata identifying the media consumed by the first user based on the first data; and
processing the second data to generate a social media profile for the first user, the social media profile identifying the media consumed by the first user.
